(19) United States
(12) Patent Application Publication
(10) Pub. No.: US 2015/0019628 A1
(43) Pub. Date: Jan. 15, 2015

(54) System and methods for accessing multi-origin content from web browser and application to web application testing

(71) Applicant: Wensheng Li, Longueuil (CA)

(72) Inventor: Wensheng Li, Longueuil (CA)

(21) Appl. No.: 14/330,932

(22) Filed: Jul. 14, 2014

Related U.S. Application Data
(60) Provisional application No. 61/845,549, filed on Jul. 12, 2013.

(51) Int. Cl. H04L 29/08

(52) U.S. Cl. CPC H04L 67/02
USPC 709/203

(57) ABSTRACT

The present invention discloses a system and method to allow a browser frame, tab, or window to communicate with an arbitrary number of application hosts in different domains while keeping its location constant on a client host. The invention allows all communications to occur between the web browser and any of the applications hosts and the client host while the hosts do not to have any knowledge of each other and cannot exchange data between them. The present invention thereby allows the frame, tag, or window to persist arbitrary data and programs. The system specifically allows sending arbitrary HTTP messages to the application hosts and allows receiving the associated responses, while allowing every interaction with the client host that the user browser supports (e.g. HTTP, Ajax), and allowing continuous execution of a program in the user browser frame, tab, or window.

### CROSS-REFERENCE TO RELATED APPLICATIONS

The present patent application claims the benefits of priority of U.S. Provisional Patent Application No. 61/845,549, entitled “SYSTEM AND METHODS FOR ACCESSING MULTI-ORIGIN CONTENT FROM WEB BROWSER AND APPLICATION TO WEB APPLICATION TESTING” and filed at the UNITED STATES Patent and Trademark Office on Jul. 12, 2013, incorporated herein by reference.

### FIELD OF THE INVENTION

The present invention generally relates to system and method for communicating between at least two browser windows, tabs, frames or other web container located in different domains, and more specifically to testing web application over a network or for securely testing web application in an intranet while receiving data from the internet.

### BACKGROUND OF THE INVENTION

Within the last decade, a vast number of application hosted over the Internet have been developed to meet the growing requirements of the Internet users or even to provide new services to the users. Typically, graphical user interface rendering programs called web browsers are employed by Internet users to receive, or download, the web pages from servers and display the pages on client computers. A web browser may be ran on many computing devices such as a typical computer, a netbook, a smart phone, a tablet, a game platform or any other device allowing the displays of web pages.

The rapid rise in the number of Internet users and in the amount of information being transferred by users has resulted in the increasing need to develop different types of web applications. As development speed is improved through more efficient development tools, the developed web applications must be tested in order to provide a bug free experience to Internet users.

Many testing tools have been developed in order to provide method to test web application. However, typically, a developer is constrained to test the application in a development environment located on the same domain or on the same sub-network as the web application being tested. In order to overcome the shortcomings of the existing testing tools, solutions have been developed to test web applications from a remote or external server. As example, the US patent application published under no. 2009/0037881 and the U.S. Pat. No. 7,313,564 disclose systems and methods for testing a web application from another web application hosted on another server. Both disclosures use a file mechanism, such as XML or flat file, to communicate the test instructions to the remote web application. Furthermore, the U.S. Pat. No. 7,043,546 discloses a method and system to test web application hosted on a remote server through web browsers. The method disclosed by U.S. Pat. No. 7,043,546 uses a proxy to process the response from the remote application and to record different test cases. Even if these methods and systems provide means to remotely test web applications, they require the communication of files or the addition of a proxy, thus requiring non-standard parsers and complex middleware.

An additional drawback of current systems and methods involving communication between remote testing host and tested client host, is that the application being tested has to be made public to be accessed by the testing host thereby exposing private information and technology that would be best kept secured.

Furthermore, another issue with the present systems and methods to test a web application is the inability to communicate between the testing application and the tested web application within the web browser. For security purposes, browsers restrict direct exchange of information between frames and windows residing on different domains, a safeguard known as the “Same Origin Policy”. Browsers do not allow a read-out in one frame of information from other frames if those other frames come from different servers. Furthermore, when loading an object such as a page or a frame from one server, a script loaded from a different server cannot get or set certain properties of certain browser and HTML objects in a window or frame. Finally, when the location of the browser window, frame or tab is changed (i.e. on receipt of content from a different host), the content of the window, frame or tab is erased, thus making it impossible to persist data and to execute a program without interruption.

U.S. Pat. No. 6,686,932 (“932”) disclosed a system and method allowing the sharing and transferring of large amount of data through a computer program product configured to be operable for sharing data from separate servers between browser frames. Furthermore, the U.S. Pat. No. 7,979,807 (“'807”) discloses a method for generating requests for communication and for triggering a pull from the server of a target frame. Both patents '932 and '807 requires middleware for either sharing the data or triggering a server, thus requiring complex configuration and synchronization.

U.S. Pat. No. 6,941,562 allows a web page to make JavaScript based function calls from a browser (also known as “RPC”) to a remove web server of different origin. The invention discloses a method for a browser to display a web page containing at least one JavaScript library acting as the client-side web page proxy for the RPC. Data is sent via the <script> tag. The server-side proxy receives a URL argument from the client-side proxy and set the script tag to the URL received as argument.

The latter system and method allows the communication without having complex middleware but supports only the request method. This limitation restrains the quantity of data as the URL length limit depends on the type of browser used and on the type of web server used (currently and typically being 2 kilo bytes), thus making impossible to transfer a large quantity of data at once and limiting the testing procedure.

### SUMMARY OF THE INVENTION

One object of the present invention is to provide a system and method to allow the testing of a web application hosted on a first client host from a user browser running a web application hosted on at least another application host, as the communication between the target client host and the at least one application host is impossible for security reasons.

Another object of the present invention is to provide a system and method to test a remote web application whereby the application host providing the testing software and the client host serving the test website do not have to exchange information, and may have no or limited knowledge of each other, or be unable to communicate altogether for security or network topology reasons.

Another object of the present invention is to provide a system and method to easily send arbitrary HTTP messages from a persistent web container displayed in a user browser to a foreign application host, while maintaining the constant frame location URL on the client host. Thus, the persistent web container may communicate with both the client host and the at least one application host. During the said communication, data may be persisted on any of the client host or the at least one application host and programs may be run without interruption. One skilled in the art shall understand that the term persistent web container is used without restricting its scope to browser frame as it may encompass windows, tabs, and any other similar browser entity allowing the display on content, such as HTML, text, binary or XML content.

Another object of the present invention is to provide a system and method to easily set up tests in both or any of the development and production environments. Such test configuration allows a client host to be configured exactly as the production environment, thus guaranteeing that at least one production web application will behave as tested. Furthermore, this configuration ensures that no data from the client host is communicated to the testing service provided by the at least one application host, thus addressing any potential privacy, security, and intellectual property protection concerns.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

The aforesaid and other objectives of the present invention are realized by generally providing a system and method for interacting with frames or windows connected to remote hosts. The method for interacting with browser container elements comprises the steps of communication with a client host and, independently, at least one application host. More specifically, the method comprises the steps for a persistent web container displayed in a browser or internet-enabled device to obtain a program allowing a user browser to subsequently interact freely with a client host and at least one application host while persisting data and consistently running the program in a persistent container.

The system and method requirement a minimum set of requirements to be met for its implementation. The application host needs to make the web application components available to download through HTTP requests, to persist selected information sent by the user browser, and to respond to associated HTTP requests. This can be achieved for instance by means of a Java, Web container (Tomcat, Jboss, Weblogic, WebSphere and so on)

The client host needs to be able to serve the bounce web page when receiving an HTTP get request, and to serve the website to be tested. The nature of the website dictates other requirements on the client host, but no such requirements are set by the system and method described herein.

The user browser requires internet connectivity to the application host and to the client host, and to be able to execute instructions sent by those hosts. The only requirement the system and method sets is the ability to read the html script tags and follow http redirect. All common web browsers thus support the functions required by the system and method described herein (e.g. Firefox, Internet Explorer, Chrome), which makes it very portable and robust.

To enable the fullest interaction between the user browser and the hosts, the user browser needs to handle all protocols and messages the Client and application host communicate (e.g. Javascript, HTML5). However, even if this is not the case, the system and method described herein will still be functional and apply to the subset of functions the user browser supports.

One embodiment of the present system and method allows the testing of any web application hosted on a first client host from a browser executing a web application hosted on a second application host. In a typical use case, testing can be carried out even when the application and client hosts are located on different networks.

According to one object of the present invention, a method for accessing multi-origin content from a web browser displaying at least one persistent web container to allow the transfer of data is disclosed. The method comprising the steps of requesting a page from a client host in the web browser requesting the script from at least one application host using the instructions comprised in the requested page and invoking the script in the persistent web container to exchange data between the client host and at least one application host and persist some of the exchanged data in at least one persistent web container. The page typically comprises instructions to request a script from at least one application host.

It is noteworthy that the system does not require, nor benefit from the existence of a communication channel between the client host and the application host.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIGS. 1a, 1b and 1c are sequence diagrams presenting a user browser sending and receiving arbitrary data to and from an application host in accordance with the present invention.

FIG. 2 is a sequence diagram of an initialization step for a user browser to load the web testing application in accordance with the present invention.

FIG. 3 is an example of a login page generated and displayed from the response of a application host in accordance with the present invention.

FIG. 4 is an example of a testing application page generated and displayed from the response of an application host in accordance with the present invention.

### DETAILED DESCRIPTION OF THE PREFERRED EMBODIMENT

A novel system and method for accessing multi-origin content from a web browser and an application to web application testing will be described hereinafter. Although the invention is described in terms of specific illustrative embodiment(s), it is to be understood that the embodiment(s) described herein are by way of example only and that the scope of the invention is not intended to be limited thereby.

Most modern web browsers prevent a window or a frame having received data from a host from interacting with another window or frame having received data from a different host. The method for accessing multi-origin content from a web browser abstracts away the said security restrictions and thereby eases the testing of an application located on a client host through the use of a testing computer program loaded from at least one different application host and running in a user browser. The abstraction of the security restrictions may further be achieved by a user browser interacting with at least one application host and a client host which are not allowed to communicate with each other, when only the user browser can interact with each host. The method for accessing multi-origin content from web browser and its application in accordance with the present invention comprises the steps to allow the transfer of data as if no security restriction between the application host and the client host exists while keeping the user browser frame or window location pointed to the client host. In a preferred embodiment, the method may provide the steps to test an application located on a different host.

One skilled in the art shall appreciate that the security restrictions applying to the communication between two hosts are not bypassed by the method for accessing multi-origin content from a web browser. Rather, the method comprises the steps to allow free exchange and persistence of data between the user browser frame or window, and at least one application host and a client host. Furthermore, the method for accessing multi-origin content from a web browser comprises an encapsulated mechanism to provide sending and receiving functions that automatically handle the browser security restrictions. For one skilled in the art, programming an application such as a web testing application using encapsulated mechanism is thus made easy as the knowledge of the underlying security restrictions are not required.

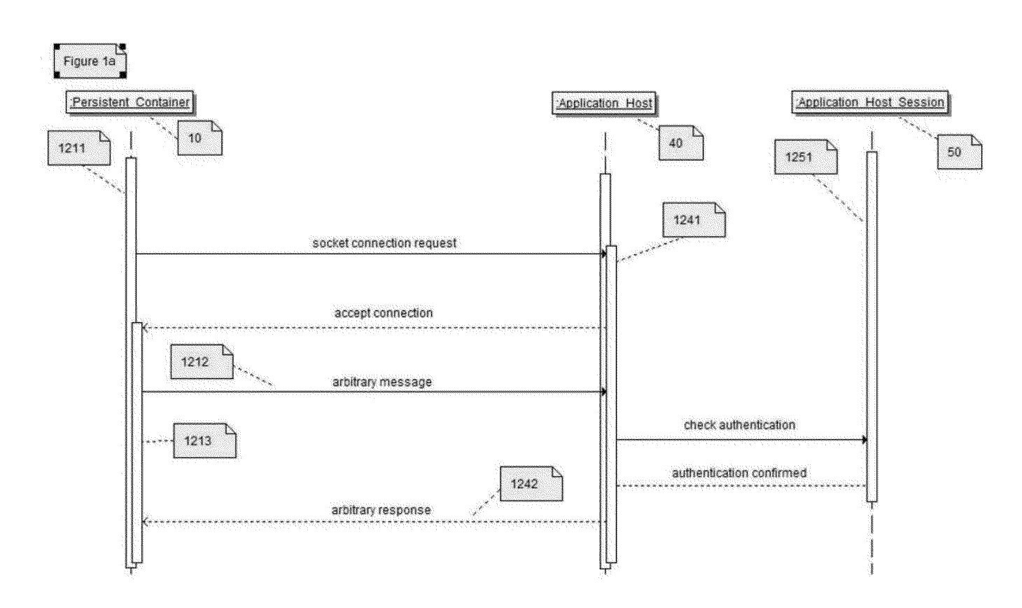

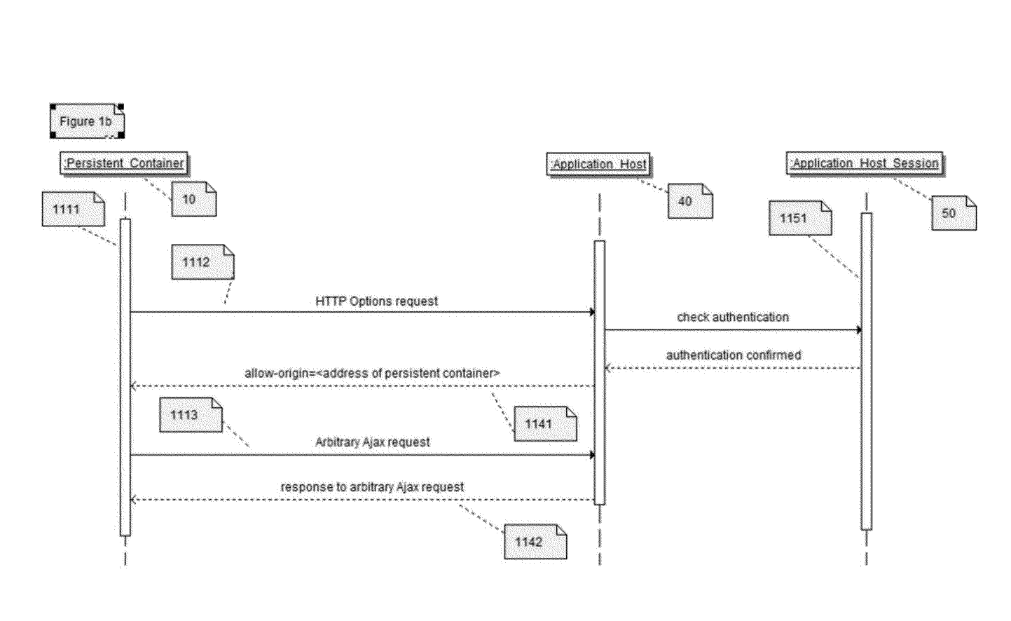

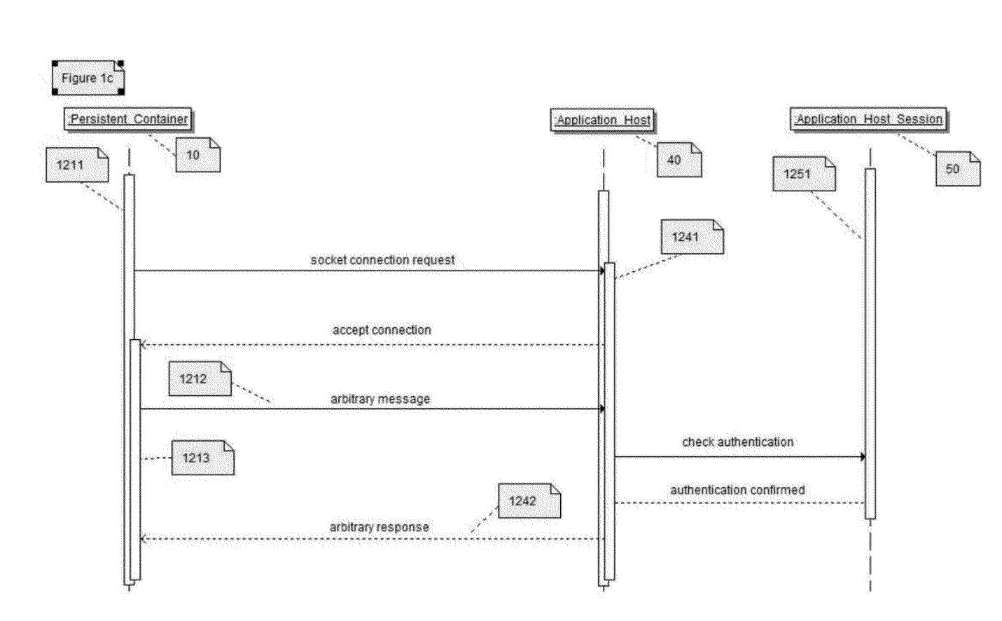

Referring to FIG. 1a, a method for accessing multi-origin content from a web browser and application is shown as a sequence diagram. The method comprises the steps to send data through arbitrary HTTP commands 121, to retrieve at least one response of any length from at least one application host through embedded scripts 112, to persist the retrieved data in a frame 10 and to interact between a web browser and a client host 30 by any available method (e.g. HTTP, Ajax). The method for interacting with frame 10 comprises the steps of communication between a client hosting device 30 and at least one application hosting device 40. More specifically, the method shown in FIG. 1a comprises the steps for a client program running in a browser container, typically a frame, a window, or a tab, 10 to send an arbitrary web request 112, typically a HTTP request such as, but not limited to Get, Post, Put, Delete, Options commands, to an application host 40, and to receive a response from at least one application host 143. The method as shown in FIG. 1a allows the uniform resource locator (“URL”) location of the web container 10 to remain unchanged while sending 112 and receiving 127 data. Thus, the web container 10 may persist the data and state throughout the lifespan 111 of the web browser container 10 and may execute a program without interruption while sending data to and receiving data from both at least one application host 40 and a client host 30. The method as shown in FIG. 1a relies on the interactions between three elements: a request web container 20, a bounce web page communicated by the client host 30, and an application host session 50.

In a preferred embodiment, the request web container 20 URL location changes during the execution of the steps of the method. During the step 121, both request web container 20 and persistent web container 10 URL locations point to the client host 30, thus enabling the persistent web container 10 to receive the request 112. The received request 112 is then forwarded 122 to the client host 30. During the step 123, the URL location request of the web container 20 points to an application host 40 as a result of an arbitrary HTTP request to the application host 122. In another embodiment, the request web container 20 may also communicate an authentication token for security purposes 122. On reception of such request 122, an application host 40 typically generates a session and persists the request information in an application host session 50.

The application host 40 communicates a response to the request web container 20 containing the instructions to load a web page from the client host 142. Typically, the instruction shall comprise the URL of the web page located on the client host 40. In a preferred embodiment, the web page is a bounce web page. Based on the received instructions, the request web container 20 requests the web page 124 from the client host 40. The web page communicated to the request web container comprises the instructions to communicate with an application host 40 and 131.

The reception of the bounce web page initiates the step 125 as the URL location of the request web container 20 is changed back to the location of the client host 30. The executions of the instructions contained in the bounce Web page 131 causes the request web container 20 to download the response 143 to the initial request 112 from the application host 40 through a script tag or through at least one Ajax request found in response 131. The URL location of the request web container 20 is unchanged by the script tag or Ajax request 126 when the response is received by the request web container 20 and 143. The request web container 20 forwards the response back to the persistent web container 10 and 127. The forwarding 127 is allowed as both web containers 10 and 20 now point to the same host, namely the client host 30. As an example of response 131, the following script tag may be included in the bounce Web page from the client host 30:

“<script src=“https://UWTester.com/get_response”></script>”

Still referring to FIG. 1a, one skilled in the art shall note that the URL location of the web page to be loaded from the client host 30 must be included within the initial HTTP request 122. The included URL location allows the application host 40 to store the requested information 141 from the persistent web container 10 in an application host session 50 and to generate the adequate instructions 142 to access the bounce web page from the request web container 20. Upon reception of the bounce web page 131, the request web container 20 will change its URL location to the client Host 30. An example of a possible response 142 to direct the request container 20 to go to the bounce Web page is:

<script>
window.location.href= “https://UWTester.com/bounce.html ”
</scripts>

The application host session 50 stores the required information in the request from the request web container 20 to the application host 40 and 122. The stored information is used by the application host 40 to prepare the response 143. On reception of the request 122, the application host 40 stores to the session 50, a short unique identifier for the request web container 20, such as, but not limited to, 256 bit random number. The above identification process allows a different request, such as 126, to only include the concise identification information instead of the full authentication information contained in an initial request 122. Separating the sending information by request 122 from the reception of the response 143 as a result of a separate request 126 eliminates the space constraints imposed by the script request 126. Thus, the method allows the persistent web container 10 to use arbitrary HTTP messages to send data 122 and to receive information of arbitrary length 143.

FIG. 1b depicts another embodiment of the method in FIG. 1a allowing the browser to support HTTP options requests having a response header comprising an allow-origin field. Still referring to FIG. 1b, the method is shown after the application host received the login credentials to initialize a session 1151. At this point in time, the URL location of the persistent web container 10 has been set to the client host 20 by requesting the bounce webpage. This state is preserved throughout the lifespan of the persistent container 1111.

In this state, the persistent web container 10 does not rely on an intermediate request web container 20 as it sends 1113 and receives 1142 data to and from the application host 40 without changing its URL location by means of script requests, such as AJAX request. One skilled in the art shall understand that the browser may validate if the script is allowed to send the request by sending an HTTP options message 1112 to the application host 40, a process known as request pre-flight in the Cross-Origin Resource Sharing W3C recommendation. Furthermore, the browser may check that the web container address is allowed by the application host 40 1141.

The application host 40 uses the current session 1151 to validate that the HTTP options request 1112 originated from a known host. If the validation succeeds, the application host 40 adds an allow-origin attribute to the response 1141, compliant with the Cross-Origin Resource Sharing W3C recommendation.

Now referring to FIG. 1c, another embodiment of the method as shown in FIG. 1a in accordance with the present invention is shown. In this embodiment, the browser supports HTML5 web sockets. Similarly to the embodiment shown in FIG. 1b, the method as shown in FIG. 1c is depicted at a step after the application host received the login credentials and has initialized a session 1251. In this state, the URL location of the persistent web container 10 is set to the client host 20 by requesting the bounce webpage.

Still referring to FIG. 1c, the persistent web container 10 does not rely on an intermediate request web container 20 as it may establish a web socket pair 1213/1241 with the application host 40 without changing the URL location, which is set to the client host 20, typically as per the Websocket API W3C recommendation and consistent with the implementation is major browsers (e.g. Firefox, Chrome) at the time of writing.

Any messages 1212, 1242 may then be communicated between the persistent web container 10 and the application host 40 while the application host stores the current state in the session 1251 previously established (e.g. during the authentication phase).

The methods of the embodiment shown in FIGS. 1b and 1c allows the location URL of the persistent web container 10 to remain on the client host's 20 bounce webpage. Thus, the persistent web container 10 may execute programs, API or web service and persist data without interruption. One skilled in the art shall understand the use of the bounce web page (single or multiple) to set the URL location to the client host combined with the use of the described method, using techniques such as request frame, script, Ajax request and/or web socket, allows to send and receive data to and from the application host 40 without altering the location URL of the persistent container 10.

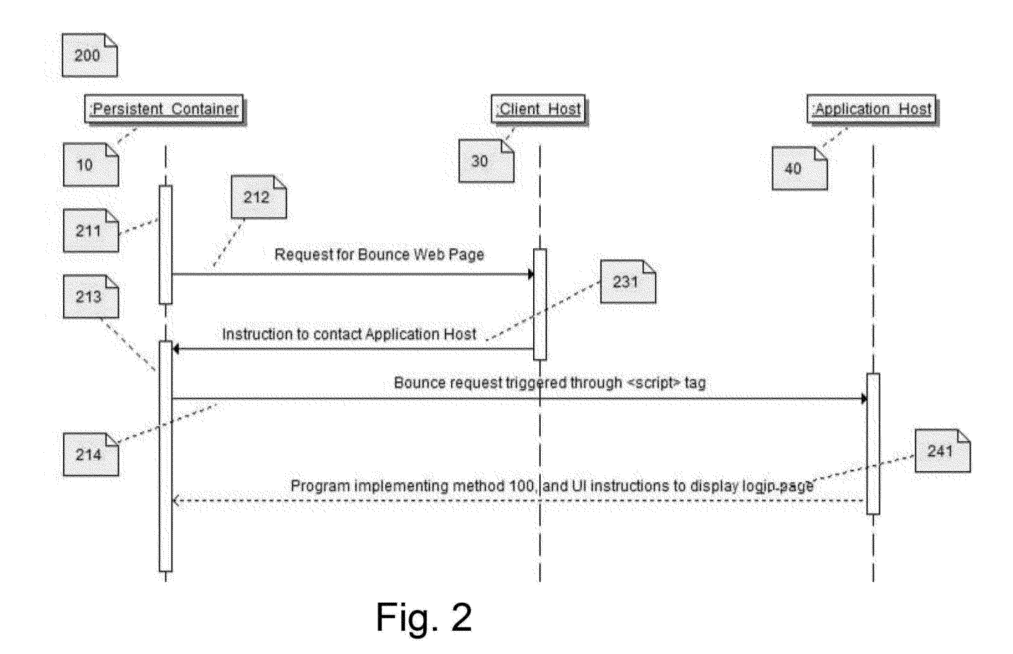

Now referring to FIG. 2, an embodiment of a method for loading a predefined program from an application host 40 allowing a persistent web container 10 to point to the URL location of a client host 30 is presented as a sequence diagram. This embodiment is a specialization of the method presented in FIGS. 1a, 1b or 1c. In this embodiment, the step in FIG. 1a sending data to the application host 40 to request information and to create the associated application host session 50 is not present when compared with the embodiment shown in FIG. 2. In the method shown in FIG. 2 the application host 40 responds to the bounce request 214 with a response comprising the predefined program and login page user interface rendering instructions 241 to any persistent web container 10 accessing the application host 40 without a valid session.

The method in FIG. 2 comprises the step for the persistent web container 10 to send a request to the client host 30 requesting a bounce web page 212 and 231. During the step 231, the location of the persistent web container 10 points to the client host 30 during the reception of the response containing the bounce web page 231. As in the previous embodiment, the bounce web page comprises instructions for the persistent web container 10 to send a bounce request to the application host 40 and 214. The instructions received by the persistent web container 231 are executed via a script tag or an AJAX request. By nature of Ajax and script tag requests, the persistent web container 10 retains the URL location of the client host 30 when the response 241 is received from the application host 40. The response 241 comprises the user interface instructions to be executed to authenticate the persistent web container 210 in one more future requests using the method described above and in FIG. 1a.

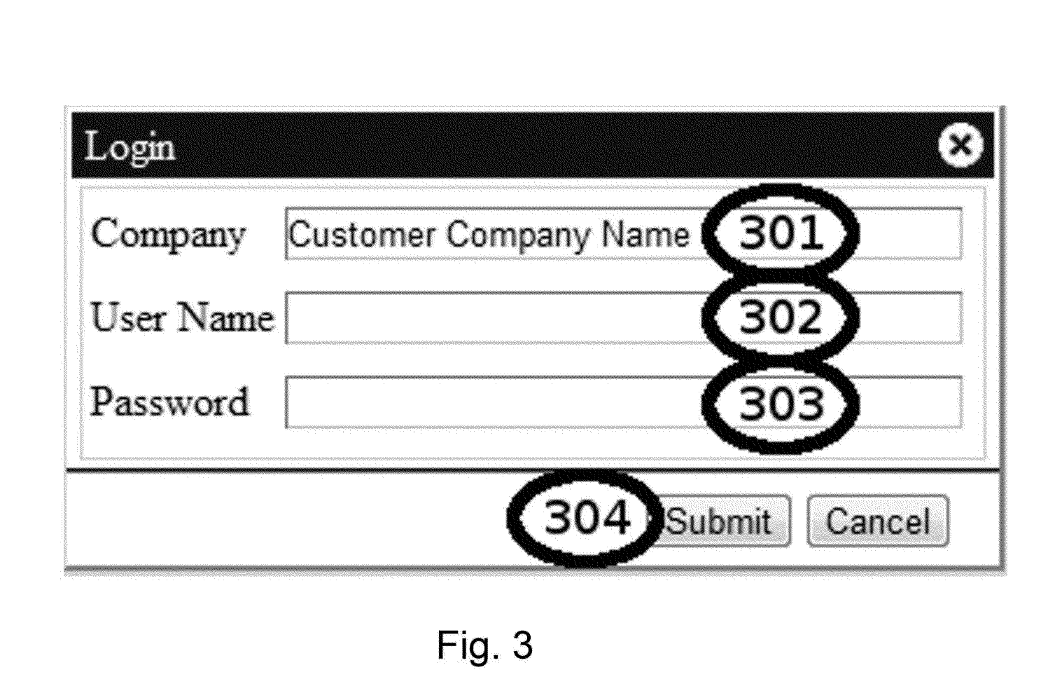

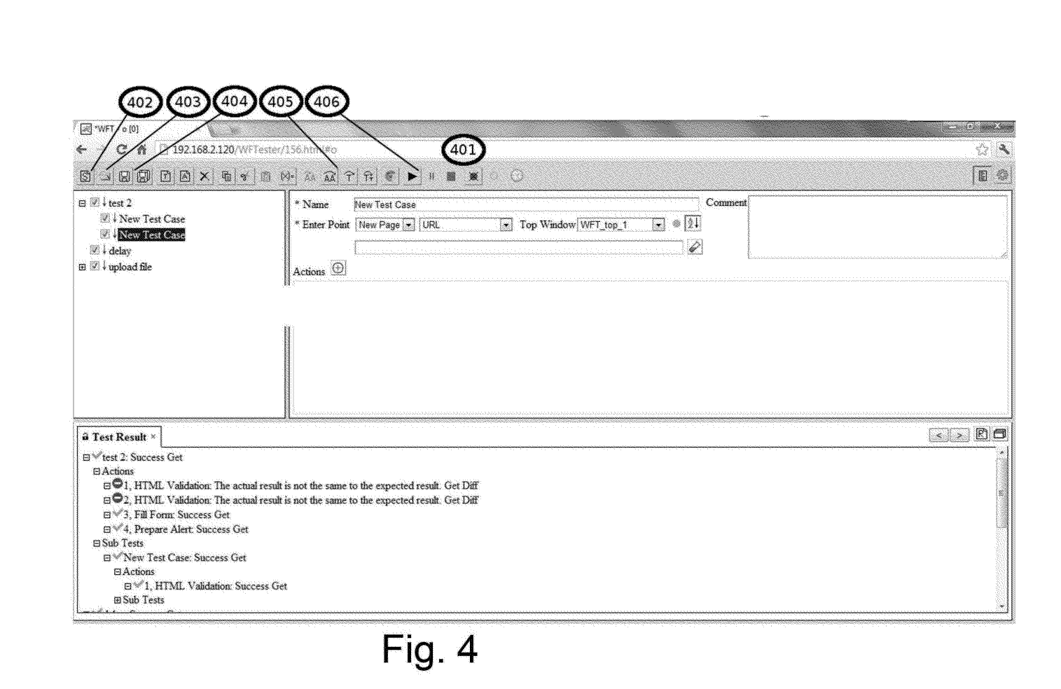

Now referring to FIG. 3, a login screen generated from the response prepared by the application host 40, as seen in FIGS. 1a, 1b, 1c, and 2, is shown. In a preferred embodiment, a user shall enter the required authentication codes, such as the company name 301, a user name 302 and a password 303, and submit the authentication information to the application host 40 through a web request, such as HTTP commands Post or Get, using a button or link 304, thus generating a request to the application host 40. However, as shown in FIGS. 1a, 1b, and 1c, the web request 304 and response uses an encapsulated mechanism, thus keeping the location of the persistent web container 10 on the client host 30. As shown in FIG. 4, the URL 401 points to the client host 30, but the content and page structure is provided by the application host 40.

As outlined in FIG. 2, the user browser receives the user interface instructions to be executed by the persistent web container 10 to allow the user to perform testing, as the interactions with the client host 30 are allowed, and while the sending and reception of arbitrary data to and from the application host 40 is based on the required data to be exchanged to test a web application and for a user to interact with the user interface.

Now referring to FIG. 4, an example of a generated page allowing remote testing of a web application 400 is shown. The generated page 400 comprises one or many links or buttons allowing to execute a test 402, to open a new test set 403, to save one or more test set 404, to execute the test on a step-by-step basis or to step over a function or method 405 or to trigger the start and stop of the executed test set 406. The present invention is not limited to the present testing functions as many other functions or commands may be added in order to test a remote web application.

In a preferred embodiment, the generation and displaying of a web page from an application host 40 is realized through the execution of scripting code through the user browser in a persistent web container 10 allowing the creation of DOM objects and properties. More specifically, languages such as JavaScript through the use of AJAX methods allows the dynamic generation of a page. In other embodiments, any scripting or programming language may be used to generate or display the page. In further other embodiments, the application host 40 response may comprise static web page to be loaded in the browser.

In another embodiment, any web page instruction and data structure may be sent to the client browser in order to be remotely executed.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1. A method for accessing multi-origin content from a web browser displaying at least one persistent web container to allow the transfer of data, the method comprising:
requesting a page from a client host in the web browser, wherein the page comprises instructions to request a script from at least one application host;
requesting the script from the at least one application host using the instructions comprised in the requested page;
invoking the script in the persistent web container to:
exchange data between the client host and the at least one application host;
persist some of the exchanged data in the at least one persistent web container.

2. The method for accessing multi-origin content from a web container as claimed in claim 1 wherein the location of the web browser container remains unchanged while exchanging the data.

3. The method for accessing multi-origin content from a web container as claimed in claim 2, wherein the request to the script from the at least one application comprises the URL location of the client host and wherein the method further comprises the step for:
the at least one application host to initialize an application host session on reception of the request for the script;
the application host to store the URL location comprises in the request;
the application host to generate the instructions to access the page from the client host.

4. The method for accessing multi-origin content from a web container as claimed in claim 2, wherein the script requested from the application host comprises the instructions to display a login page.

5. The method for accessing multi-origin content from a web container as claimed in claim 4, wherein the displayed login page comprises fields to enter the login credentials.

6. The method for accessing multi-origin content from a web container as claimed in claim 3, wherein the script requested from the application host comprises the instructions to display page to perform testing and wherein the sending and reception of data to and from the application host is based on the required data to be exchanged to test a web application and for a user to interact with one or more user interfaces of the tested web application.

7. The method for accessing multi-origin content from a web container as claimed in claim 6, wherein the page to perform testing allows one or many of the following actions:
execute one or more tests or test sets;
load one or more tests or test sets;
save one or more tests or test sets;
execute one or more tests or test sets on a step-by-step basis;
step over a function or method;
trigger the start and stop of an test or test set in a state of execution.

8. The method for accessing multi-origin content from a web container as claimed in claim 1, wherein the instructions comprised in the requested are in a HTML <script> element.

9. The method for accessing multi-origin content from a web container as claimed in claim 2, wherein the instructions comprised in the requested are run using an AJAX request.

10. The method for accessing multi-origin content from a web container as claimed in claim 2, wherein the data exchanged between the client host and the at least one application host comprises instructions to be executed to authenticate the web container.

11. The method for accessing multi-origin content from a web container as claimed in claim 2, wherein the exchange of data is done by:
establishing a web socket pair with at least one application host using the instructions comprised in the requested page;
communicate data between the web container and the at least one application host by exchanging messages through the established web socket;
store the communicated date in the application host session.

12. The method for accessing multi-origin content from a web container as claimed in claim 11, wherein the script requested from the application host comprises the instructions to display page to perform testing and wherein the sending and reception of data to and from the application host is based on the required data to be exchanged to test a web application and for a user to interact with one or more user interfaces of the tested web application.

13. The method for accessing multi-origin content from a web container as claimed in claim 12, wherein the page to perform testing allows one or many of the following actions:
execute one or more tests or test sets;
load one or more tests or test sets;
save one or more tests or test sets;
execute one or more tests or test sets on a step-by-step basis;
step over a function or method;
trigger the start and stop of an test or test set in a state of execution.

14. The method for accessing multi-origin content from a web container as claimed in claim 1, wherein the exchange of data is done by:
the persistent web container to send a HTTP options request to the at least one application host;
the application host to validate the presence of the field allow-origin in the received script request;
the application host to add a field allow-origin in the response to the persistent web container.

15. The method for accessing multi-origin content from a web container as claimed in claim 14, wherein the script requested from the application host comprises the instructions to display page to perform testing and wherein the sending and reception of data to and from the application host is based on the required data to be exchanged to test a web application and for a user to interact with one or more user interfaces of the tested web application.

16. The method for accessing multi-origin content from a web container as claimed in claim 15, wherein the page to perform testing allows one or many of the following actions:
execute one or more tests or test sets;
load one or more tests or test sets;
save one or more tests or test sets;
execute one or more tests or test sets on a step-by-step basis;
step over a function or method;
trigger the start and stop of an test or test set in a state of execution.
